(19) United States
(12) Patent Application Publication
(10) Pub. No.: US 2026/0148264 A1
(43) Pub. Date: May 28, 2026

(54) Automated System and Method for Matching and Connecting Donors with Recipients

(71) Applicant: The Global Orphan Project, Inc., Kansas City, MO (US)

(72) Inventors: Joseph Knittig, Parkville, MO (US); Adrien M. Lewis, Stilwell, KS (US); Tyler A. Fisk, Kansas City, MO (US)

(73) Assignee: The Global Orphan Project, Inc., Kansas City, MO (US)

(21) Appl. No.: 19/401,727

(22) Filed: Nov. 26, 2025

Related U.S. Application Data
(60) Provisional application No. 63/725,770, filed on Nov. 27, 2024.

(51) Int. Cl. G06Q 30/0279; G06F 21/62; G06Q 20/40

(52) U.S. Cl. CPC G06Q 30/0279; G06F 21/6218; G06Q 20/401

(57) ABSTRACT

A computer-implemented platform facilitates donor-recipient matching with professional-gated intake and church-centric stewardship. A request intake interface receives care requests from approved professionals; a source verification module confirms permitted account origin and domain affiliation, rejecting non-conforming submissions. A responder registry stores responder profiles including church entities. A matching engine computes preferences using proximity, urgency, and responder type and selects a lead church steward. A communication subsystem sends notifications and establishes messaging channels. A payment governance subsystem routes donations to a request-specific fund and issues a payment token bound to the request identifier and steward identity. A spending control module constrains purchases to goods and services matching the need specification. An audit ledger associates authorizations and settlements with the request identifier and steward payment token. A post-engagement verification interface captures various indicators, feedback, and responder narratives, and calculates economic impact of the donation.

### CROSS-REFERENCE TO RELATED APPLICATIONS

This application claims the benefit of U.S. Provisional Ser. No. 63/725,770, filed Nov. 27, 2024, entitled “Automated System and Method for Matching Donors with Recipients,” currently assigned to The Global Orphan Project, Inc. (assignment recorded at Reel 069483/Frame 0264), the entirety of which is incorporated by reference.

### FIELD OF THE INVENTION

The present invention relates to computer-implemented systems and methods for coordination of community care. More specifically, it concerns automated platforms that accept professionally gated care requests, match those requests to proximate church entities that serve as relational stewards, transfer request specific funding through steward bound payment credentials and spending constraints, and capture engagement verification metrics and narratives.

### BACKGROUND OF THE INVENTION

Communities frequently mobilize churches, nonprofits, donors, and individual responders to meet urgent needs for families and individuals, often in coordination with social-service agencies. Existing platforms commonly support intake, some level of validation, proximity-weighted matching, communications, and donation facilitation. However, these systems typically permit self-posted needs or broadly sourced submissions without a strong professional gating requirement, do not require selection of a local church or relational steward prior to fund access, lack request-specific payment governance that ties authorization to a specific steward identity and verified need, and offer limited capture of meaningful connection indicators, engagement narratives, and relational and economic impact metrics for post-engagement verification.

As a result, trust, provenance, stewardship, and longitudinal engagement and relational support outcomes can be fragmented. Agencies and donors need stronger assurances that requests originate from approved professionals or agencies, that funds are accessible only after a steward church is selected to be a lead relational arm to engage and support recipients on a personal level, that spending aligns with an articulated need specification, and that post-engagement outcomes are captured and visible.

### BRIEF SUMMARY OF THE INVENTION

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. Said terminology will include the words specifically mentioned, derivatives thereof, and words of similar meaning.

In one aspect, a computer-implemented automated system receives care requests exclusively through a request intake interface used by approved professionals associated with agencies. In embodiments, the approved professional may be approved independently of an associated agency. A source verification module confirms that the request originates from a permitted professional or agency account and determines approved status based on prior onboarding via agency workflows. In embodiments, the source verification module further enforces domain-based affiliation checks, rejecting non-conforming submissions.

A responder registry stores responder profiles, including a set of church entities eligible to act as relational stewards. A matching engine computes match scores or preferences for prospective steward churches using a weighted function of factors including geographic proximity, urgency, and responder type, and selects a lead church entity as the relational steward. In embodiments, the matching engine employs load-balancing parameters to avoid responder saturation. In certain embodiments, the matching engine employs a predictive matching module trained to prioritize responders based on historical prevention outcomes, which may include configuring matching urgency classification to historical time-to-fulfillment metrics.

A communication subsystem dispatches notifications and establishes messaging channels among the approved professional, the lead church entity, and responders. A payment governance subsystem routes donations to a request-specific fund and, upon steward selection, issues a steward payment token bound to the request identifier. In embodiments, the token is further bound to the steward identity. A spending control module applies constraints such that funds associated with the steward payment token are usable exclusively by the lead church entity for goods and services matching the need specification, and, in embodiments, further automatically declines non-conforming transactions with alerts. In embodiments, the spending control module further enforces merchant category constraints and transaction caps.

An audit ledger associates authorizations and settlements with the request identifier and steward payment token. A post-engagement verification interface solicits and stores a meaningful-connection indicator, a user-experience rating, open-ended improvement feedback, and a responder narrative (video, audio, or text), each associated with the request identifier and lead church account, and calculates economic impact based on monetary donation values and recorded or estimated volunteer time contributions, and in certain embodiments further collects relational follow-up information and is configured such that request closure may be performed by a request submitter through a request closure module.

In method and computer-readable medium aspects, instructions implement the operations set forth above.

### BRIEF DESCRIPTION OF THE DRAWINGS

FIG. 1 is a process flow diagram depicting a series of steps 100 engaged in by the system, including a submission of a request 101, system notification to responders 102, processing of monetary donations 103 via a payment processor 104 and issuance of a payment token 105 to a lead church entity claiming the payment token 108, alongside a contemporaneous or alternative physical item donation 106 which, together with or alternative to the monetary donation 103, is matched via the system 107 to be claimed by the lead church entity 108, after which the lead church entity engages with the donation recipient to disperse the donation and engage in relational follow up 109, at which time the system records the applicable transactions 110, processes user feedback 111, and calculates donation impact 112.

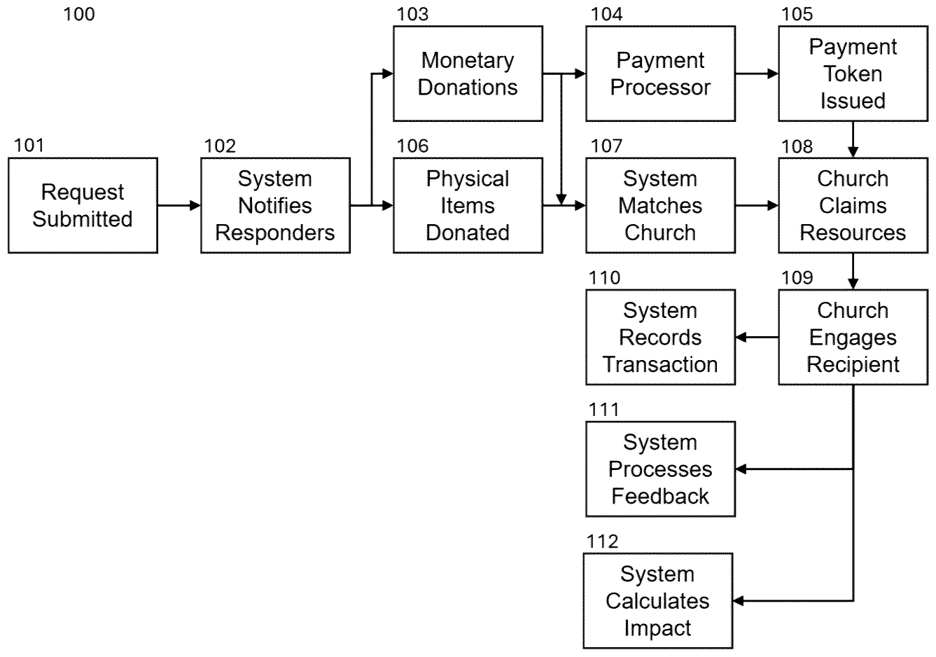

FIG. 2 is a block diagram of the system architecture 200, including the request intake interface 210, source verification module 220, responder registry 230, matching engine 240, communication subsystem 250, payment governance subsystem 260, audit ledger 270, and post-engagement verification interface 280.

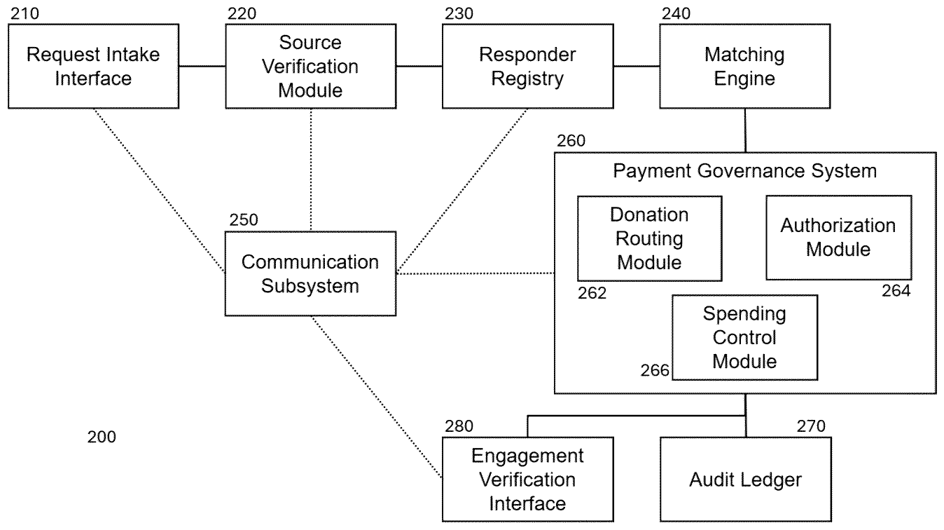

The drawings herein illustrate exemplary embodiments, and features shown may be combined or varied.

### DETAILED DESCRIPTION OF THE INVENTION

### I. Definitions and Roles

“Approved professional”: A user affiliated with a permitted social-service or partner agency, or an independent social service professional, as context requires, whose account has passed onboarding by an authorized field representative via an agency application workflow.

“Care request”: A structured submission comprising a request identifier (RID), beneficiary location, urgency classification, and need specification (e.g., itemized goods or services).

“Computer-readable media”: non-transitory storage media, such as magnetic disks, optical disks, flash memory, ROM, and RAM, that store instructions which, when executed by one or more processors, cause the processors to perform the operations described herein.

“Lead church entity” or “relational steward”: A church registered in the responder registry, eligible to be selected as the relational steward responsible for coordinating fulfillment of care requests and engagement or relational follow up with recipients.

“Steward payment token”: A credential (e.g., a card token, virtual card identifier, or similar authorization token) issued upon steward selection and bound, cryptographically or by similar means, to the RID and steward identity.

“Request-specific fund”: A dedicated fund maintained by the donation routing module and associated with a unique RID.

“Spending constraints”: Policy and technical controls enforced by the spending control module (e.g., merchant category constraints, transaction caps, and optional auto-decline with alerts).

“Post-engagement verification metrics”: Structured artifacts and narratives including indicators qualifying whether a connection was meaningful, ratings, open-ended feedback, and responder narratives, plus economic impact calculations.

### II. System Architecture

The system 200 comprises:

Request intake interface 210. The interface receives care requests from approved professionals associated with agencies and captures RID, beneficiary location (e.g., geo coordinates or region), urgency classification (e.g., tiers such as high/medium/low), and need specification (e.g., beds, food, clinic visits). The interface enforces role-based access controls and can exclude requests from sources not pre-verified unless approved manually.

Source verification module 220. The module performs three checks, which are not limited to the following order: confirm origin from a user account associated with a permitted professional or agency; determine approved status by referencing records produced during prior onboarding conducted by authorized field representatives via agency workflows; and enforce domain-based affiliation checks for the submitting account (e.g., email or identity domain policies). Requests failing any of these checks are rejected.

Responder registry 230. The registry stores responder profiles including responder type (e.g., church, business, nonprofit), geographic location, and availability, with a set of church entities eligible for stewardship. Availability may include capacity and open case counts.

Matching engine 240. The engine computes match scores or preferences for church entities using a weighted function of proximity, urgency, and responder type. Load-balancing parameters reduce selection likelihood for saturated responders and help distribute stewardship assignments. The engine selects a lead church entity as the relational steward, which the lead church entity may accept.

Communication subsystem 250. The subsystem dispatches notifications and establishes secure messaging channels between the approved professional and the lead church entity, and with one or more responders. Channels may include email, SMS, or in-app messaging. In certain embodiments, the communication subsystem is configured to allow the community to engage with individual churches, and to allow churches to message and interact with responders, to collaborate on meeting needs. In certain embodiments, the system provides a mapping interface to represent local churches in proximity to the request being entered, and in further embodiments, the system includes an activity feed module for each request through which the community can ask questions, write a prayer, or otherwise celebrate or interact in connection with needs being met.

Payment governance subsystem 260 comprising:
a. Donation routing module 262. The donation routing module receives donations associated with the RID and holds them in a request-specific fund. No funds are accessible or disbursed unless a lead church entity is selected as the relational steward.
b. Authorization module 264. Upon stewardship selection, the authorization module issues a steward payment token bound to the RID and steward identity. In certain embodiments, the token is provisioned to a lead church entity and implemented as a card credential bound to the request-specific fund via payment processor integration.
c. Spending control module 266. The spending control module applies constraints to ensure the steward payment token authorizes expenditures exclusively matching the need specification. In embodiments, the module automatically declines non-conforming transactions with alerts; enforces merchant category constraints; and one or more transaction caps (per-transaction, daily, or total) tied to the need specification.

Audit ledger 270. The ledger associates each authorization or settlement with the RID and the steward payment token, and can record merchant identifiers, amounts, timestamps, locations (where available), and reconciliation status.

Post-engagement verification interface 280. The interface solicits and stores: a meaningful-connection indicator (e.g., binary or graded); a user platform rating (user-experience rating); open-ended improvement feedback; and responder narratives via video, audio, or text. Each submission is associated with the RID and the lead church account. The interface calculates economic impact based on donation monetary values and recorded or estimated volunteer time contributions (e.g., hours multiplied by a configurable economic value per hour).

### III. System Functionality

Upon request submission, the system validates required fields and invokes the source verification module, which employs origin confirmation from permitted professional or agency accounts, approved status determination referencing onboarding records (e.g., time-stamped approval by a field representative), and, in embodiments, domain-based affiliation checks (e.g., organization email domain and identity records). In embodiments, the source verification module may function in connection with an agency case-management system connected via an application programming interface. Requests that fail any check are rejected and in embodiments may trigger user messaging advising resolution steps. In certain embodiments, the system is configured to process requests for goods, services, and monetary donation.

The responder registry indexes church entities with geo coordinates and current availability. The matching engine: computes match scores using weighted inputs for proximity, urgency, and responder type; in embodiments, applies load-balancing parameters to avoid responder saturation (e.g., maximum concurrent stewardship limit), and selects a lead church entity, and in embodiments may present one or more alternate lead church entities if the lead declines or times out. The system then dispatches invitations/notifications to the selected steward and opens messaging channels upon acknowledgment.

When a lead church entity is selected, the donation routing module maintains donations in the request-specific fund associated with the RID. The authorization module issues the steward payment token and, in certain embodiments, provisions to a lead church entity a card credential via processor integration, binding the credential to the request-specific fund. In certain embodiments, the steward payment token and card credential provisioning may integrate with standard payment processors. The spending control module enforces constraints aligned with the need specification. Example policies include merchant category constraints (e.g., groceries, furniture, healthcare services), and transaction caps. In certain embodiments, the system automatically declines non-conforming transactions and issues alerts to the steward and approved professional.

The audit ledger records authorizations or settlements keyed by RID and steward payment token. Ledger entries can include merchant data, amounts, timestamps, and approval codes. In embodiments, reporting interfaces present fulfillment status and funding utilization, supporting transparent auditability and reconciliation.

The communication subsystem sends notifications to the approved professional and lead church entity (e.g., upon stewardship selection, funding status, attempted non-conforming purchase alerts) and supports secure messaging among stakeholders. In embodiments, communication channels can be configurable per role and region.

After fulfillment activities, the system prompts for post-engagement submissions, which may include: a meaningful-connection indicator (indicating whether a relational connection occurred); user platform rating; open-ended user feedback; and responder narratives, which may be supported via video, audio, or text submission. In embodiments, the meaningful-connection indicator may include categories indicating the quality of the connection. In certain embodiments, submissions are stored with RID and lead church account metadata. The system calculates economic impact based on donation value and recorded or estimated volunteer time contributions, which in certain embodiments are displayed in dashboards and reports.

### IV. Example Use Case

By way of example only, a caseworker may submit a care request (RID) for two beds and bedding, and in such case, urgency may be high and the beneficiary location may be within a defined radius. The source verification module may confirm the caseworker's permitted account, approved onboarding status, and domain affiliation. The matching engine may select a nearby church steward using weighted proximity and urgency with load-balancing. Donations may flow into the RID-specific fund, and upon steward selection, a tokenized card credential may be provisioned. The spending control module may authorize purchases aligned to the need specification at allowed merchants and caps per transaction, and a non-conforming attempt may trigger an auto-decline alert. The audit ledger may record such transactions or attempted transactions. Post-engagement, the steward may submit a narrative and meaningful-connection indicator and the system may calculate economic impact based on recorded or estimated volunteer hours and donation value.

It is to be understood that while certain embodiments, aspects, and/or use cases of the present invention have been shown and described herein, the invention is not limited thereto and encompasses various other embodiments, aspects, and use cases.

What is claimed is:

1. A computer-implemented automated system for matching and connecting donors with recipients comprising:
a request intake interface configured to receive, from an approved professional associated with a social-service or partner agency, a care request including a request identifier, a beneficiary location, an urgency classification, and a need specification;
a source verification module configured to:
(i) confirm that the care request originates from a user account associated with a permitted professional or agency;
(ii) determine the professional's or agency's approved status based on prior onboarding performed by an authorized field representative via an agency application workflow; and
(iii) enforce domain-based affiliation checks for the submitting account, wherein requests that fail any of (i)-(iii) are rejected;
a responder registry storing responder profiles comprising at least a responder type, a geographic location, and availability, the responder registry including a set of church entities eligible to act as relational stewards;
a matching engine configured to compute match scores or preferences for a plurality of church entities according to a weighted function of geographic proximity to the beneficiary location, the urgency classification, and the responder type, the matching engine further utilizing load-balancing parameters to address responder saturation and to select a lead church entity as a relational steward for the care request;
a communication subsystem configured to dispatch notifications to the approved professional and to the selected lead church entity and to establish messaging channels therebetween and with one or more responders;
a payment governance subsystem comprising:
(i) a donation routing module configured to receive monetary donations associated with the request identifier and to hold the donations in a request-specific fund, wherein no funds are disbursed or accessible unless a lead church entity is selected as the relational steward;
(ii) an authorization module configured to, upon selection of the lead church entity, issue a steward payment token bound to the request identifier and the steward identity; and
(iii) a spending control module configured to apply constraints to ensure that funds associated with the steward payment token are usable exclusively by the lead church entity to acquire goods and services matching the need specification; and
an audit ledger configured to associate each authorization or settlement with the request identifier and the steward payment token; and
a post-engagement verification interface configured to:
(i) solicit and store an indicator qualifying whether a meaningful connection occurred;
(ii) solicit and store a rating qualifying a user's platform experience;
(iii) solicit and store open-ended improvement feedback;
(iv) accept and store a responder narrative provided via video, audio, or text, wherein each submission is associated with the corresponding request identifier and the lead church account; and
(v) calculate an economic impact of a donation based on the monetary value of the donation and an amount of volunteer time recorded or estimated to have been contributed by responders.

2. The system of claim 1, wherein the request intake interface enforces role-based access control that excludes needs requested by a source that has not been pre-verified unless approved manually.

3. The system of claim 1, wherein the authorization module provisions a card credential to a lead church entity and binds the credential to the request-specific fund via a payment processor integration.

4. The system of claim 1, wherein the spending control module automatically declines non-conforming transactions with alerts.

5. The system of claim 1, wherein the spending control module enforces merchant category constraints and one or more transaction caps tied to the need specification.

6. The system of claim 1, wherein a rule engine requires recordation of relational follow-up milestones by the request submitter in coordination with the approved professional before the care request is marked complete.

7. The system of claim 1, further comprising a geographic mapping interface in which prospective lead churches are displayed in proximity to the beneficiary location, and in which the community can engage with individual churches and collaborate on prospective request satisfaction.

8. The system of claim 1, further comprising a predictive matching module trained to prioritize responders based on historical prevention outcomes and time-to-fulfillment metrics.

9. A computer-implemented method for matching and connecting donors with recipients, the method comprising:
receiving, via a request intake interface, a care request originated by an approved professional associated with a social-service or partner agency, the care request comprising a request identifier, a beneficiary location, an urgency classification, and a need specification;
verifying, via a source verification module, professional affiliation and request sourcing, and, if verification fails, rejecting the care request;
accessing a responder registry comprising responder profiles including a set of church entities eligible to act as relational stewards;
computing, via a matching engine, match scores or preferences for the set of church entities based on a weighted function of geographic proximity to the beneficiary location, the urgency classification, and a responder type attribute, utilizing load-balancing parameters to avoid responder saturation, and selecting a lead church entity as a relational steward for the care request;
dispatching, via a communication subsystem, notifications to the approved professional and to the lead church entity, and establishing messaging channels therebetween and with one or more responders;
routing monetary donations associated with the request identifier to a request-specific fund and restricting access or disbursement of the fund unless the lead church entity is selected as the relational steward;
issuing, upon selection of the lead church entity, a steward payment token bound to the request identifier and the steward identity;
applying, by a spending control module, constraints to ensure that funds associated with the steward payment token are usable exclusively by the lead church entity to acquire goods and services matching the need specification;
recording, in an audit ledger, authorizations and settlements associated with the request identifier and the steward payment token; and
collecting, via a post-engagement verification interface, relational follow-up information comprising at least one of: a meaningful-connection indicator, a user-experience rating, open-ended feedback, and a responder narrative in video, audio, or text, each associated with the request identifier and the lead church account, and calculating an economic impact based on the monetary value of the donation and an amount of volunteer time recorded or estimated to have been contributed.

10. The method of claim 9, wherein issuing the steward payment token comprises provisioning a card credential to a lead church entity and binding the credential to the request-specific fund via a payment processor integration.

11. The method of claim 9, wherein applying the constraints comprises automatically declining non-conforming transactions with alerts.

12. The method of claim 9, wherein applying the constraints comprises enforcing merchant category constraints and one or more transaction caps tied to the need specification.

13. The method of claim 9, further comprising requiring, by a rule engine, recordation of relational follow-up milestones by the lead church entity in coordination with the approved professional before the care request is marked complete.

14. The method of claim 9, further comprising associating physical item donations with the request identifier and facilitating coordination of pickup and delivery logistics with the lead church entity.

15. The method of claim 9, further comprising prioritizing church entities for stewardship assignment and restricting fund release unless a church entity is selected.

16. A non-transitory computer-readable medium storing instructions that, when executed by one or more processors, cause the processors to perform operations comprising:
receiving, via a request intake interface, a care request originated by an approved professional and comprising a request identifier, a beneficiary location, an urgency classification, and a need specification;
verifying, via a source verification module, professional affiliation and request sourcing, and, if verification fails, rejecting the care request;
selecting, via a matching engine implementing a weighted matching algorithm with load-balancing parameters, a lead church entity as a relational steward based on geographic proximity, urgency, and responder type;
dispatching notifications and establishing messaging channels between the approved professional, the lead church entity, and one or more responders;
routing donations to a request-specific fund and restricting access or disbursement of the fund unless the lead church entity is selected as the relational steward;
issuing a steward payment token bound to the request identifier and the steward identity;
applying constraints, by a spending control module, to ensure that the steward payment token authorizes expenditures exclusively matching the need specification;
recording, in an audit ledger, authorizations and settlements associated with the request identifier and the steward payment token; and
collecting, via a post-engagement verification interface, relational follow-up information comprising at least one of: a meaningful-connection indicator, a user-experience rating, open-ended feedback, and a responder narrative in video, audio, or text, each associated with the request identifier and the lead church account, and calculating an economic impact based on the monetary value of the donation and an amount of volunteer time recorded or estimated to have been contributed.

17. The non-transitory computer-readable medium of claim 16, wherein applying the constraints comprises declining transactions outside a configured policy and issuing alerts upon attempted non-conforming purchases.

18. The non-transitory computer-readable medium of claim 16, wherein issuing the steward payment token comprises provisioning a card credential to a lead church entity and binding the credential to the request-specific fund via a payment processor integration.

19. The non-transitory computer-readable medium of claim 16, wherein applying the constraints comprises enforcing merchant category constraints and one or more transaction caps tied to the need specification.

20. The non-transitory computer-readable medium of claim 16, wherein the instructions further cause the processors to prioritize church entities for stewardship assignment and to restrict fund release unless a church entity is selected.
